(19) United States
(12) Patent Application Publication
(10) Pub. No.: US 2009/0031530 A1
(43) Pub. Date: Feb. 5, 2009

(54) Adjustable Hinge for Doors and Windows

(76) Inventor: Alessandro Barca, Napoli (IT)

Correspondence Address: THE H.T. THAN LAW GROUP, WATERFRONT CENTER SUITE 560, 1010 WISCONSIN AVENUE NW, WASHINGTON, DC, 20007, US

(21) Appl. No.: 12/183,837

(22) Filed: Jul. 31, 2008

(30) Foreign Application Priority Data
Jul. 31, 2007 (IT) NA2007U000027

(51) Int. Cl. E05D 7/04

(52) U.S. Cl. 16/243; 16/235

(57) ABSTRACT

A hinge for doors and/or windows, adjustable in three dimensions: height, width, and depth. The hinge has a total of four support and/or attachment pins, two fixed and two moveable, and can be used with doors and/or windows of various thicknesses, by means of threaded pins passing through the center of the hinge, but off center, which reduce the protrusion of the attachment and/or support pins of the door and/or window, giving the hinge superior technical and esthetic characteristics compared to the current state of the art. The hinge has a rotation pin not attached to the hinge that permits the door and/or window to be adjusted in height, which gives superior technical characteristics compared to the current state of the art.

The present invention relates generally to hinges and more particularly to an adjustable hinge for use with doors and windows.

The present invention provides a hinge for doors and/or windows, adjustable in three dimensions: height, width, and depth. The hinge has a total of four support and/or attachment pins, two fixed and two movable, and can be used with doors and/or window of various thicknesses, by means of threaded pins passing through the center of the hinge, but off center, which reduce the protrusion of the attachment and/or support pins of the door and/or window, giving the hinge superior technical and esthetic characteristics compared to the current state of the art. The hinge has a rotation pin not attached to the hinge that permits the door and/or window to be adjusted in height, which gives superior technical characteristics compared to the current state of the art.

The foregoing and other embodiments will be described in detail below with reference to the drawings provided herewith.

### BRIEF DESCRIPTION OF THE DRAWINGS

The features and advantages of the present invention will become more readily apparent from the following Detailed Description of the Drawings of the invention in which like elements are labeled similarly, and in which:

FIG. 1 is an exploded side view of the hinge according to the principles of the present invention;

FIG. 2 is a side view of FIG. 1 shown assembled;

FIG. 3A is an end view of the hinge of FIG. 1 and FIG. 2 showing the attachment of a threaded attachment pin to a hinge body;

FIG. 3B is a perspective view of a threaded attachment pin;

FIG. 4 is a perspective view of the hinge of the present invention with covering caps that surrounds the hinge entirely, hiding all the attachment and/or adjustment mechanisms from view;

FIG. 5 is a is a perspective view of the hinge of the present invention, showing a rotation pin received in one hinge body;

FIG. 6 is a front view of the hinge of the present invention showing a blind holes that have received a screw and threaded hold containing a regulating screw;

FIG. 7 is a side view of the hinge of the present invention in use on a window or door;

FIG. 8 is a side view of a prior art hinge in use on a window or door.

### DETAILED DESCRIPTION OF THE DRAWINGS

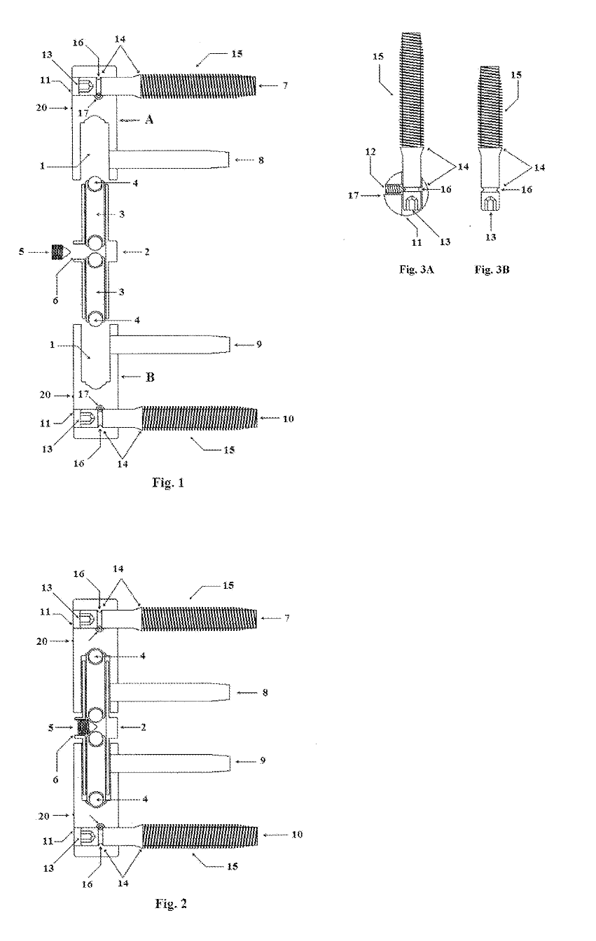

Referring to FIG. 1, in an embodiment of the present invention two hinge bodies (A and B) each having a cylindrical shape, in which a blind cylindrical seat (1) is made in the vertical direction, receive a rotation pin (2). The rotation pin (2), combined with the two hinge bodies (A and B), create the assembly constituting the hinge of the present invention (H), as shown assembled in FIG. 2. A significant special feature of the profile is the rotation pin (2), which, compared to known hinges, is not an integral part of the hinge, but a free body, which makes the production phases simpler and faster. Another special feature is that the rotation pin (2) has two other moveable mobile pins (3) inside of it. Different from the single pin present in commercial hinges; this special feature gives the possibility of adjusting the hinge twice as much as known hinges, and it makes the adjustment system stable and balanced, because the two opposite forces of the mobile pins (3) make the load balanced on the regulating screw (5).

In the current commercial hinges, adjustment in the vertical direction takes place only through a single rotation pin, which has the potential of breaking under the stress of the adjustment system. The mobile pins (3) are moveable axially and have steel balls (4) surrounded on every side by a movable mobile pin (3) for purposes of reducing wear. The mobile pins (3), placed axially in the rotation pin (2) are activated by means of a screw (5) placed in a threaded hole (6), which, when screwed in and out, makes the mobile pins (3) move in the vertical direction, giving a possibility of adjusting the door and/or window in the vertical direction twice as much as in the known hinges.

Referring to FIG. 1, rotation pin (2) and the attachment pins (7, 10) or support pins (8, 9), which are placed perpendicular to the axis of rotation are significant; they do not pass through its center, but off center, which give characteristics that make the single hinge unique in its type. Rotation pin (2), as a free body, is therefore not an integral part of the hinge, making it much simpler and faster to produce than the hinge bodies (A and B). They can be made in the same machine equal to each other, which is not possible with other hinges, since the hinge bodies are different from each other, and therefore two different machines are needed to produce them.

In both hinge bodies (A and B), an attachment pin and a support pin (7 and 8) and (9 and 10) are placed perpendicular to the axis of rotation, not passing through its center, but off center, of which a support pin (8 and 9) is smooth and attached permanently to the hinge body, and the attachment pin (7 and 10) is threaded and movable and placed in openings (11) passing through hinge bodies (A and B), remaining fixed or unfixed with a screw (12).

The movement of the threaded pin (7 and 10) with respect to hinge body (A) and the hinge body (B) permit the door and/or window to be adjusted in the width and depth directions, in addition to attaching and supporting the door and/or window. The threaded attachment pins (7 and 10), not being permanently attached to the hinge bodies (A and B), making the production of the hinge simple and faster, because the processing phase requiring later machining to attach the pin to the hinge, as in all other known hinges, is eliminated. The smooth support pins (8 and 9) are shorter than the threaded attachment pins, in order to be compatible with doors and/or jambs of different thicknesses. The threaded attachment pins (7 and 10), not being permanently attached to the hinge bodies (A and B) have the characteristic of being replaceable with pins of various lengths, based on the thickness of the doors and/or windows and the jambs used.

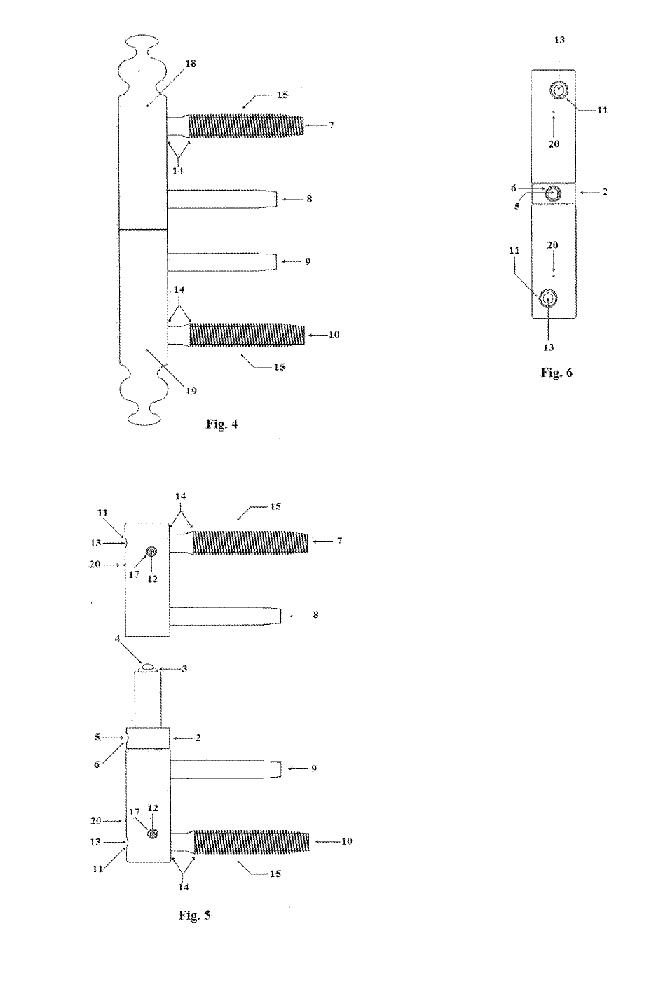

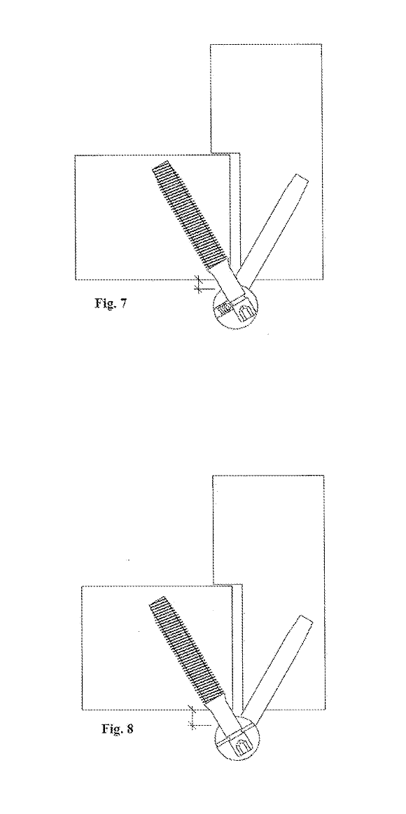

Referring to FIGS. 5 and 6 the attachment pins (7 and 10) are structured in three basic parts, a head of the pin with a blind hole (13) made in the head of each prepared for a fixing key or adjusting key, which can have a different type of drive, for example, hexagonal, square, cross or star. As shown in FIG. 5, the neck of the pin (14) is smooth and polished, because it is partially visible; the threaded body (15), which will have the function of being screwed, due to the rotation of corresponding attachment seats in the door and/or window and in the jamb.

Referring to FIGS. 1, 2, 3A and 3B, there are grooves (16) between the heads of the threaded pins and the neck along the circumference, which will achieve the purpose of receiving screws (12) screwed into threaded holes (17) made in the hinge bodies (A and B), perpendicular to the pins, for blocking and/or dismounting the attachment pins (7 and 10).

Having the attachment and support pins (7, 8, 9, 10) off center permits them to be less visible, since they mostly penetrate into the door and/or window and the jamb. A simplified example is shown in FIG. 7, which is esthetically more pleasing compared to other known hinges, which encounter resistance to being used just because of their less pleasing esthetic factor, with consequent commercial damage, as shown in the simplified example of a prior art hinge in FIG. 8.

Another important point regarding the off-center pins is that they penetrate better into the door and/or window, the lever arm turns out to be significantly reduced, and therefore the hinge works with less force and consequently less wear, and has a greater capacity with the same amount of work applied to them, as is shown in FIG. 7.

In an embodiment of the hinge of the present invention, the hinge may be made both with various circumferences and dimensions and with all threaded pins movable and interchangeable and with different axes. The hinge turns out to simple and functional in its structure, which consists of few parts and can be made with both stamping and turning machines. For the end user, it will have certain advantages, being easy to assemble, adjustable, versatile, secure, resistant, pleasing in appearance, and therefore more valid commercially. To protect the dismountable parts, there are covering caps (18 and 19)—FIG. 4, that surround the hinge entirely, hiding all the attachment and/or adjustment mechanisms from view and therefore also avoiding the possibility that they can be unscrewed accidentally, and make the structure of the hinge unstable, said covering caps also performing the function of making the hinge refined and pleasing in appearance. They can be made, finished, and formed from various materials. The hinge bodies (A and B) have rough absorbing surface made on the surface, with a punched surface that will serve to make it more stable by fitting the caps to the hinge bodies, thus avoiding accidental movement of the caps (18 and 19), as is shown in FIG. 4.

While the foregoing description and drawings represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials and components, without departing from the spirit or essential characteristics thereof. One skilled in the art will appreciated that the invention may be used with many modifications of structure, arrangement, proportions, materials, and components and otherwise, used in the practice of the inventions, which are particularly adapted to specific environments and operative requirements without departing from the principles of the present invention. The presently disclosed embodiments are therefore to be considered in all respects as illustrative and not restrictive, the scope of the invention being indicated by the appended claims, and not limited to the foregoing description.

What is claimed is:

1) A hinge comprising a first hinge body and a second hinge body connected when assembled along an axis of rotation by a rotation pin with a first end and a second end,
said first hinge body comprising
a. an attachment pin that is attached to the first hinge body,
b. a support pin that is attached to the first hinge body,
c. a seat,
whereby both the attachment pin and the support pin are off-centre and perpendicular to the axis of rotation,
said second hinge body comprising
a. an attachment pin that is attached to the second hinge body,
b. a support pin that is attached to the second hinge body,
c. a seat,
whereby both the attachment pin and the support pin are off-centre and perpendicular to the axis of rotation;
said seat in the first hinge body receives the first end of the rotation pin and said seat in the second hinge body receives the second end of the rotation pin,
said rotation pin comprising a mobile pin at the first end of the rotation pin and a second mobile pin at the second end of the rotation pin, said mobile pins being moveable by activation means.

2) The hinge of claim 1, wherein the hinge bodies and the rotation pin are cylindrical.

3) The hinge of claim 1, wherein the two mobile pins contain steel balls on each end of both pins.

4) The hinge of claim 1, wherein the activation means comprises a regulating screw that is placed in a threaded hole provided in the rotation pin which, when screwed in and out, makes the mobile pins move along the axis of rotation.

5) The hinge of claim 4, wherein the threaded hole is in the center of the rotation pin.

6) The hinge of claim 1, wherein the attachment pin and support pin of the first hinge body attach to a door jamb and the attachment pin and support pin of the second hinge body attach to a door frame.

7) The hinge of claim 1, wherein the attachment pin and support pin of the first hinge body attach to a window and the attachment pin and support pin of the second hinge body attach to a window frame.

8) The hinge of claim 1, wherein the attachment pins are replaceable and the support pins are permanently attached to the hinge bodies.

9) The hinge of claim 1, wherein the attachment pins have three parts, a head with a blind hold adapted to receive an adjusting key, a neck that is smooth and a threaded body.

10) The hinge of claim 1, wherein the support pins have a smooth surface and are shorter than the attachment pins.

11) The hinge of claim 1, wherein a covering cap surrounds the hinge entirely.

12) The hinge of claim 1, wherein the surface of the hinge bodies are rough for the purpose of holding the covering cap in place, and providing for an aesthetically pleasing hinge.
